(19) United States
(12) Patent Application Publication
(10) Pub. No.: US 2014/0182703 A1
(43) Pub. Date: Jul. 3, 2014

(54) Inflatable Ear Canal Inserted Device

(71) Applicant: Gideon Williams Duvall, Boca Raton, FL (US)

(72) Inventor: Gideon Williams Duvall, Boca Raton, FL (US)

(21) Appl. No.: 14/133,613

(22) Filed: Dec. 18, 2013

Related U.S. Application Data
(60) Provisional application No. 61/797,927, filed on Dec. 18, 2012.

(51) Int. Cl. H04R 1/10

(52) U.S. Cl. CPC H04R 1/1041
USPC 137/223

(57) ABSTRACT

An orifice occluding inflatable device comprising a fluid pumping system operable to flow fluid, a fluid flow management system operable to selectively control fluid flow, an inflatable balloon system operable to dilate and contract in response to the flow of fluid and cause orifice occlusion, a locking mechanism preventing undesired actuation of the fluid flow management system, a complementary systems package configured to be coupled to orifice occluding inflatable device, a complementary systems package operable to actuate the fluid flow management system through linear or rotary movement of a protrusion and a pressure relief valve in fluidic connection with the ambient atmosphere and occluded orifice configured to mitigate a pressure differential.

### CROSS REFERENCE TO RELATED APPLICATION

This Application claims priority to U.S. Provisional Patent Application No. 61/797,927 filed on Dec. 18, 2012, the entirety of which is incorporated by reference.

### FIELD OF THE INVENTION

The present invention deals with inflatable ear canal inserted devices that are operated in part or completely by a force applied to and translated through adjacent biological tissue or mechanical components in operable connection.

### BACKGROUND OF THE INVENTION

Currently disclosed inflatable orifice inserted devices are actuated/operated by external force directly applied by a prime mover to a mechanical actuator. This configuration presents practical problems as a successful consumer biologically implanted or inserted device must be of minimal size with any mechanical actuators fitting within this size envelope. Frequently this results in the actuating surface being smaller than the average diameter of a human fingertip thus requiring high levels of dexterity for operation.

The present invention is applicable in inflatable orifice inserted devices. Over time, many devices have been disclosed that utilize an inflatable device inserted into a body cavity such as an ear canal as exemplified by patents: U.S. Pat. Nos. 3,602,654, 4,133,984, 4,834,211. These devices are typically composed of a pumping means, fluid control means, and inflatable balloon. If scaled large enough, currently disclosed inflation and deflation techniques can be made operable requiring acceptably low levels of dexterity. However, in reality, a commercially successful device must comply with the size requirements dictated by the consumer. As illustrated in the applicable prior art, the multitude of currently disclosed inflation and deflation techniques require high levels of dexterity and/or impractically large actuation surfaces impeding consumer adoption. Thus, there is a need for an inflation and deflation system that can satisfy the size and dexterity requirements of the consumer thereby making inflatable in ear canal inserted devices viable consumer products. Furthermore, a successful device will be of sufficiently small size that it is able to be integrated with additional complementary technologies, such as microphones and speakers that take advantage of the benefits of ear canal occlusion provided by an inflatable device, while still meeting the size and operational requirements of the consumer.

### SUMMARY OF THE INVENTION

In order to satisfy the established need, an orifice inserted inflatable device is configured such that device inflation and deflation is actuated/operated by forces readily applied to distinctly different surfaces roughly the diameter of a human fingertip or larger regardless the physical size of the device's mechanical actuator. Additionally, the external prime actuation forces should be successfully applied in an inexact fashion with general directionality. Lastly, the actuation forces should be unique in that natural movement of the body does not cause undesired actuation.

To achieve these three criteria, an exemplary system includes the typical components of: fluid pumping system (FPS), fluid flow management system (FFMS), and inflatable balloon system (IBS). FPS pumps fluid through the application of force on an actuation surface; FFMS manages flow into and out of the IBS utilizing the application of force on an actuation surface to modify flow in at least one direction. In use, the device is configured such that one or both of the aforementioned actuation surfaces is mechanically connected to human tissue adjacent to the actuator. Both the actuator and mechanically connected tissue are designed to be readily actuated by a generally applied force. Lastly, the systems are configured such that they are actuated by unique forces not generated or encountered by the mechanically connected tissue during the course of daily activities.

Additionally, the inflatable ear inserted device may be coupled to a Complementary Systems Package (CSP) that may possess complementary technologies, such as microphones and speakers that take advantage of the benefits of ear canal occlusion provided by an inflatable device. The CSP may be configured such that it incorporates mechanical components that are in operable connection with an actuator surface of the device and are configured to cause actuation through the application of force from a prime mover to the mechanical component which transfers said force to the actuator surface in operable connection.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 Illustrates an exemplary embodiment of the described invention inserted in a human ear with protruding pinna removed;

FIG. 2 Illustrates a cross sectional view of a non-limiting embodiment of an exemplary ear canal inserted inflatable device;

FIG. 3 Illustrates a cross sectional view of an alternate non-limiting embodiment of an exemplary inflatable ear canal inserted inflatable device;

FIG. 4 Illustrates a cross sectional view of an alternate non-limiting embodiment of an exemplary inflatable ear canal inserted device;

FIG. 5: illustrates a cross sectional view of the embodiment depicted in FIG. 2 inserted in the human ear of FIG. 1;

FIG. 6: Illustrates an embodiment as shown in FIG. 5 in an alternate state;

FIG. 7 Illustrates an embodiment as shown in FIG. 5 in an alternate state;

FIG. 8 Illustrates an embodiment as shown in FIG. 5 in an alternate state;

FIG. 9 illustrates a cross sectional view of the embodiment depicted in FIG. 3 inserted in the human ear of FIG. 1;

FIG. 10 Illustrates an embodiment as shown in FIG. 9 in an alternate state;

FIG. 11 Illustrates an embodiment as shown in FIG. 9 in an alternate state;

FIG. 12 Illustrates an embodiment as shown in FIG. 9 in an alternate state;

FIG. 13 illustrates a cross sectional view of the embodiment depicted in FIG. 4 inserted in the human ear of FIG. 1;

FIG. 14 Illustrates an embodiment as shown in FIG. 13 in an alternate state;

FIG. 15 Illustrates an embodiment as shown in FIG. 13 in an alternate state;

FIG. 16 Illustrates an embodiment as shown in FIG. 13 in an alternate state;

FIG. 17 Illustrates embodiment shown in FIG. 3 with an alternate configuration;

FIG. 18 Illustrates an alternate embodiment of device shown in FIG. 3;

FIG. 19 Illustrates a isometric view of an alternate non-limiting embodiment of an exemplary ear canal inserted inflatable device;

FIG. 20 Illustrates embodiment depicted in FIG. 19 inserted in a user's ear;

FIG. 21 is an alternate embodiment of the device depicted in FIG. 35 shown inserted in a human ear;

FIG. 22 is a cross section of the embodiment depicted in FIG. 21;

FIG. 23 is a isometric view of the embodiment depicted in FIG. 22

FIG. 24 illustrates an isometric view of the two components that comprise the embodiment depicted in FIG. 23;

FIG. 25 is an alternate isometric view of the embodiment of FIG. 22

FIG. 26 illustrates an isometric view of the two components that comprise the embodiment depicted in FIG. 22;

FIG. 27 illustrates an isometric view of an alternate embodiment of the device depicted in FIG. 22;

FIG. 28 illustrates an isometric view of the two components that comprise the embodiment depicted in FIG. 27;

FIG. 29 is an alternate isometric view of the embodiment of FIG. 27;

FIG. 30 illustrates an isometric view of the two components that comprise the embodiment depicted in FIG. 27;

FIG. 31 is a human ear with an alternate embodiment of device depicted in FIG. 22 inserted and the lower portion of the helix and ear lobule removed;

FIG. 32 illustrates an isometric view the embodiment of the device depicted in FIG. 31;

FIG. 33 illustrates an isometric view of the CSP depicted in FIG. 32 with a portion of the actuator cover removed

FIG. 34 depicts an alternate embodiment of the device configured to utilize rotary movement of for device actuation;

FIG. 35 illustrates a cutaway of the embodiment of FIG. 34 depicting the system for translating rotary motion into an appropriate actuation motion;

FIGS. 36 and 37 are isometric views of an alternate embodiment of the device of FIG. 31 which utilizes linear motion to actuate the device;

FIG. 38 is an isometric cutaway view of the embodiment of FIGS. 36 and 37 depicting the mechanism for transferring vertically applied force onto the appropriate actuation surface;

FIG. 39 is device of FIG. 22 with pressure differential mitigating valves;

FIG. 40 illustrates the embodiment of FIG. 39 in an alternate state; and

FIG. 41 is an isometric view of the device of FIG. 39.

### DETAILED DESCRIPTION OF EXEMPLARY EMBODIMENTS OF THE PRESENT INVENTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

Although the invention is illustrated and described herein with reference to specific embodiments, the invention is not intended to be limited to the details shown. Rather, various modifications may be made in the details within the scope and range of equivalents of the claims and without departing from the invention.

An exemplary system includes the typical components of: fluid pumping system (FPS), fluid flow management system (FFMS), and inflatable balloon system (IBS).

FPS

The FPS provides the driving force for fluid (liquid and/or gas) movement throughout the device and may be an open or closed system, with the open system utilizing ambient air as a fluid and the closed system using air or a liquid. In the case of a closed system, the liquid will ideally possess certain qualities that are optimal for mechanical, electrical, biological safety, and acoustical requirements. With regards to mechanical/physical properties, the fluid should have a viscosity below 10 cp, possess a pour point below −20° C., boil at a temperature above 80° C., be non-flammable, and have a low specific heat. With regards to biological safety, the liquid must be biologically compatible, evaporate from human skin leaving no residue in less than 24 hours and be non-flammable. Electrically, the fluid should be a dielectric such that any rupture of the FPS, FFMS, or IBS will not have a permanent negative impact on the electrical performance of adjacent electronics. Additionally, a dielectric fluid will prevent potentially dangerous transfer of electrical energy to operably connected tissue in the event of a fluid leak. When the device is used to occlude and provide attenuation to an ear canal, the higher the liquid density, the higher the attenuation. An exemplary fluid is the class of fluids known as fluorocarbons. Depending on the molecular structure, the physical properties of these fluids varies; however, the vast majority of distinct fluids within the fluorocarbon family possess the aforementioned qualities and have been heretofore not enumerated by prior art. An exemplary fluid is FC-770 manufactured by 3M. As the system is closed, preventing diffusion of fluid into and out of the device is critical, thus the FPS should be designed such that the overall system is of ultra-low permeability.

Optimally, the FPS is designed such that pumping/actuation force results in movement of fluid through the FFMS into the IBS without an appreciable increase in any FPS dimensions. Such an FPS design enables device operation in a minimal size envelope and maximum mechanical efficiency. With regards to the actuation of the FPS, depending on the design requirements, the FPS may be operated through direct force applied from a prime mover, such as a finger, or operated by an indirect force translated through adjacent operably connected tissue. The depicted embodiments of the FPS place it within the concha, however, depending on design requirements, it may be positioned within the ear canal or moved behind the ear or another alternate appropriate location. As will be obvious, in a sealed or closed system, the FPS reservoir volume should be made large enough to provide sufficient fluid to inflate the IBS to its fully inflated state.

In the case where an open system is desired, ambient air is used as the inflation fluid. A hole may be strategically placed on the actuation surface of the FPS such that the prime mover covers the hole creating a seal of sufficient integrity to enable the entrapped fluid to be pumped through the FFMS into the IBS. The FPS preferably possesses a spring constant that upon a decrease of contained fluid and removal of the prime mover results in the production of a negative pressure within. The removal of the prime mover preferably unseals the hole of the FPS and ambient fluid replaces the fluid that was pumped through the FFMS in response to the negative pressure within the FPS enabling it to return to its pre-actuated state. In the event that the FPS is of insufficient size to fully inflate the IBS to the desired diameter and/or pressure with one pump, the open system FPS may be pumped several times to achieve the desired IBS inflation. In order to ensure that the operation of the FFMS is not hindered by particulate matter that may be introduced through the hole, a filter media may be placed such that particulate matter of detrimental size is unable to enter the reservoir of FPS. In the case of an open system, FPS permeability requirements are not as demanding as those required for a closed system and must only be sufficient to pump ambient air to the required pressure with an acceptable level of efficiency.

FFMS

In fluidic connection to the FPS is the FFMS which is also fluidic connection to the IBS. The FFMS manages fluid flow between the FPS and IBS. The FFMS has at least two states, static and actuated. In its static state, the FFMS preferably allows minimally impeded one way flow of fluid from the FPS into the IBS thereby inflating the balloon. Additionally its static state, prevents flow out of the IBS thus acting as a one way check valve. In its actuated state, the FFMS facilitates minimally impeded flow out of the IBS into the FPS or alternate location when deliberate mechanical input from an actuating force is applied to its actuator surface. In use, this actuation surface is ideally configured such that it is operably connected to an adjacent tissue, such as the tragus, which receives a force from a prime mover, such as a finger, and transfers it to the actuator surface through operably connected tissue, causing the FFMS to transition from the static state to the activated state enabling movement of fluid out of the IBS. In a closed FPS system, the driving force for movement of fluid out of the IBS is provided by its surrounding impinged tissue, any compression provided by the elastic properties of the IBS, and negative pressure within the FPS generated as a result of its compressed state and inherent spring constant. In an open system, the driving force for fluid flow out of the IBS is provided by its surrounding impinged tissue and compression provided by the elastic properties of the IBS.

As will be obvious, FFMS may utilize a multitude of different styles of valves, such as duckbill, poppet, flapper, umbrella, etcetera, or a combination therein, as long as the aforementioned operation is achieved. Utilizing tissue operably connected to the FFMS actuation surface to transfer the actuating force enables the actuating surface to be made smaller than the size of the prime mover and be positioned such that it is not fully exposed to the prime mover thus facilitating miniaturization of the overall inflatable ear canal inserted device.

Depending on the overall system design requirements, it may be found advantageous to design said inflatable ear canal inserted device such that actuation of FPS is performed utilizing force translation through adjacent tissue and the FFMS is actuated through direct force application. Alternately, both FPS and FFMS may be actuated through force translation through adjacent tissue.

In practice, the FFMS actuation surface may be integrated into the physical walls of the FPS as in the depicted embodiments. However, as will be obvious, it is important to integrate the two systems in a fashion that ensures that actuation of the FFMS does not result in unintended activation of the FPS or vice versa. Additionally, the integration of the two systems must be accomplished in a fashion that ensures that the action forces for both FPS and FFMS are not too large making the device painful and difficult to operate. Optimization may be accomplished by variance of device wall thickness and/or material durometer along with the design of the FPS and FFMS.

IBS

The IBS is in fluidic connection to both the FPS and FFMS with the FPS supplying fluid to the IBS and the FFMS regulating the flow of fluid into and out of the IBS. In practice, the IBS consists of an inflatable balloon which is primarily designed to impinge upon the walls of the ear canal creating an acoustic seal. The inflatable portion of the IBS may be comprised of an elastic membrane conventionally referred to as a compliant balloon, exemplary materials would be latex, TPU (low durometer), or silicone. Alternately an inelastic balloon, also known as a non-compliant balloon may also be utilized, exemplary materials include but are not limited to high durometer TPU, PET, Pebax and Nylon. Additionally, a hybrid system composed of a non-compliant balloon with a compliant balloon on top may be utilized. In the later embodiment, the fluid is contained within the underlying non-compliant balloon with the compliant balloon used to provide compression, improve aesthetics, and modify the acoustical characteristics of the system. In a hybrid system, an appropriate biocompatible lubricant should be utilized to minimize the friction between compliant and non-compliant balloons thereby minimizing inflation pressure. Exemplary lubricants would include fluorosilicone oil and Teflon used between a TPU non-compliant balloon and silicone rubber compliant balloon hybrid system.

As will be understood by those skilled in the art, when determining the optimal balloon material, chemical compatibility, biocompatibility, permeability and system inflation pressure should be of primary concern. With regards to inflation pressure, the pressure required to dilate the balloon should be kept as low as possible; factors affecting inflation pressure include compliant balloon modulus and intra-balloon friction. As will be obvious to the user, the inflation pressure required during use will be determined by the user and will be a function of: overall IBS design, ear canal diameter and geometry, compliance of the user's ear canal, and their desired “feel” for the device in their ear canal. Regardless of the pressure selected by the user, the FPS and FFMS should be designed to deliver said pressure with the least amount of force required by the prime mover actuating the FPS actuation surface. Factors affecting the actuation force required to generate the desired IBS fluid pressure include FPS pumping efficiency, pressure required to change the state of FFMS from blocking flow to allowing flow into the IBS (crack pressure), and fluid resistivity within the FFMS. As will be obvious to those skilled in the art, FPS efficiency should be made as high as possible and FFMS crack pressure and resistivity as low as possible.

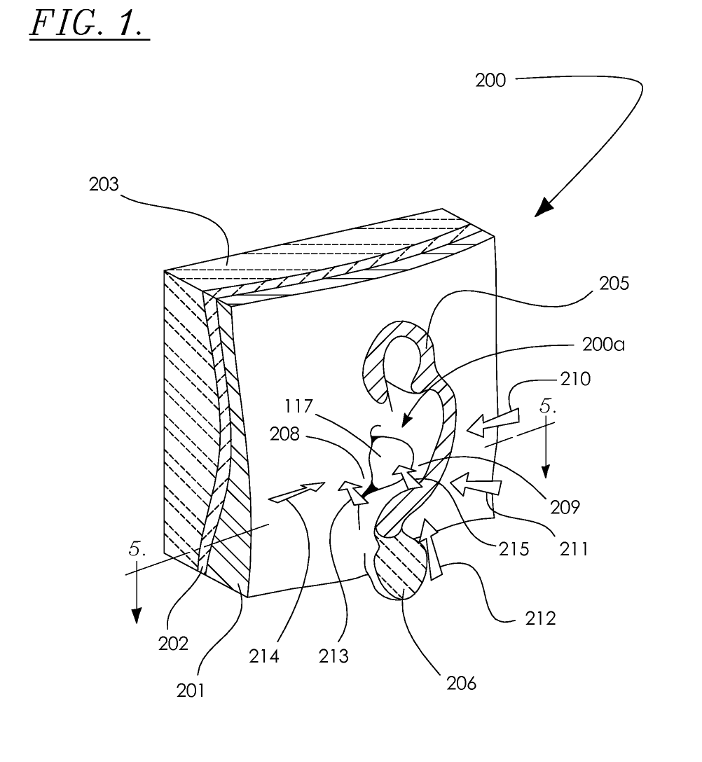

Referring to FIG. 1, an exemplary system is shown. Ear region 200 depicts a human ear with the protruding pinna removed revealing the pinna's inner cartilaginous portion 205 and lobule tissue 206. Additionally depicted are inner skull region 203, skull bone 202 and outer skull soft tissue 201, tragus 208, and concha 209. Depicted inflatable ear inserted device 200a is positioned in concha 209 with exposed FPS actuation surface 117.

The pinna 205 and tragus 208 of a human contain cartilage that provides structure to the outer skull soft tissue 201 surrounding the ear canal (not shown). This pinna cartilage 205 is held in place by outer skull soft tissue 201 which is in turn attached to skull bone 202. The ear canal goes from its opening at the floor of the concha 209 into the inner skull region 203 through skull bone 202. This presents a unique scenario where the ear canal is essentially fixed in place by the skull bone and the surrounding ear structure is able to be deformed, translated or shifted around its opening through the application of external force such as forces 210, 211, 212, 213, and 214. During the course of daily motions of the human body, ear region 200 experiences no forces of sufficient magnitude to result in appreciable deformation around the ear canal. Thus, the present invention takes advantage of the ability to provide unique deliberate deformation of the tissue approximate the ear canal via unnatural forces, such as force 210-214, applied to large and readily accessible surfaces, such as the backside of the pinna 205 and tragus 208, transferring these forces through the biological tissue to perform deliberate actuations of the inflatable ear inserted device 200a without directly contacting the device.

Depending on specific device design requirements, it may be found advantageous to utilize the aforementioned force transfer method of device actuation with direct force actuation for operation of either the FPS or FFMS of inflatable ear inserted device 200a. Referring to FIG. 1, FPS actuation surface 117 is configured to receive force 215 directly from a prime mover, such as the user's finger, causing the movement of fluid from the FPS through the FFMS into the IBS causing balloon inflation.

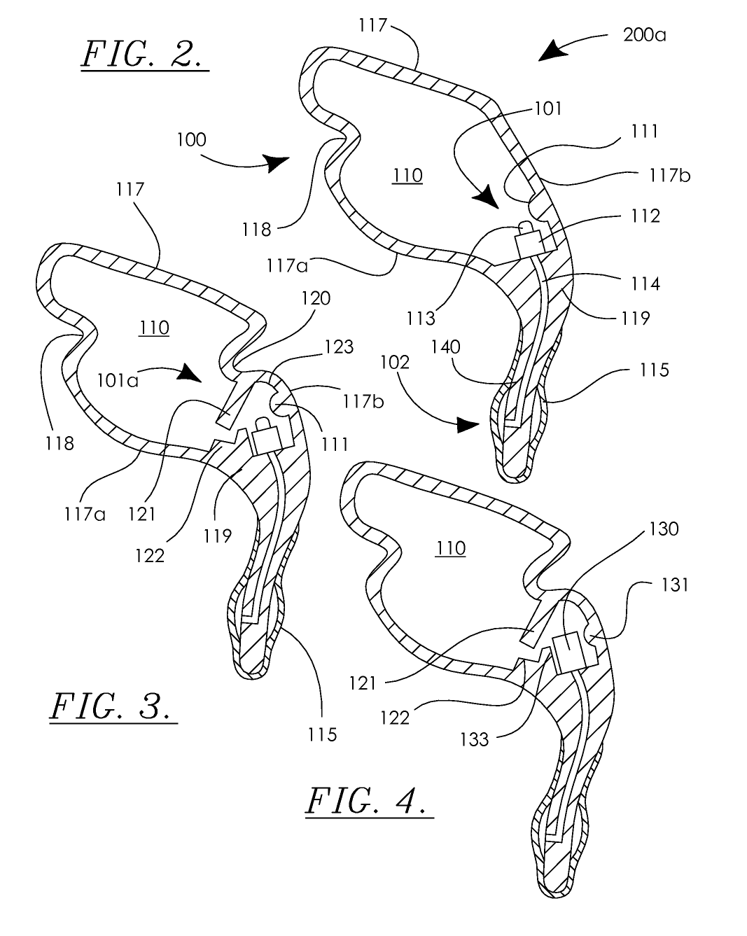

Referring to FIG. 2, the device depicted is an exemplary non-limiting embodiment of inflatable ear inserted device 200a depicted in FIG. 1. The device is composed of three primary systems, the FPS 100, FFMS 101, and the IBS 102. In this embodiment, all three systems are contained within one contiguous device body 119. Depending on the design requirements, device body 119 may be composed of multiple materials and multiple components, however, in this embodiment; they are all formed as one. As will be obvious to those skilled in the art, in practice device body 119 will need to be made from at least two components. Regardless the number of materials utilized, materials should be biocompatible, durable, have good compression set and be sufficiently soft (typically between 35 and 60 durometer Shore A). In the case of an open system, permeability of the device body material is less important and thus higher permeability elastomers, such as silicone rubber, may be utilized to make device body 119. In the case of sealed systems, the permeability of device body 119 is of high importance, thus an optimal material will be of exceptionally low permeability. An exemplary elastomer is butyl rubber. As previously described, the FPS 100 contains an interior fluid reservoir 110, compression guide groove 118, FPS actuation surface 117, and restoring force surface 117a.

FFMS 101 is composed of flow regulation device 112 that includes actuator 113 which is configured to receive an actuating force from flow regulation device mover 111 which is in operable connection with FFMS actuating surface 117b. As depicted in FIG. 2, flow regulation device mover 111, and actuation surface 117b may be incorporated into device body 119.

IBS 102 is composed of balloon system 115, which may be composed of a single balloon of the compliant or non-compliant variety or alternately a hybrid system as previously described. IBS 102 includes balloon system 115 bonded to shaft 140 which is in operable connection to FFMS 101 via conduit 114. As depicted in FIG. 2 shaft 140, and conduit 114 may be incorporated in device body 119.

The device depicted in FIG. 3 is an alternate non-limiting embodiment of inflatable ear inserted device 200a. In this embodiment IBS 102 is identical to that of the embodiment depicted in FIG. 2, additionally, the function and operation of FPS 100 and FFMS 101 are identical. However, the FFMS 101a of device depicted in FIG. 3 incorporates a mechanical system to prevent any potential undesired actuation of flow regulation device 112. This mechanical protection system consists of FFMS actuator lock flap 121, FFMS actuator lock seat 122, FFMS protection compression groove 120 and FFMS protection system pivot point 123.

FIG. 4 depicts an alternate non-limiting embodiment of inflatable ear inserted device 200a which has identical operation of systems IBS 102, FFMS 101, and FPS 100 as the embodiments depicted in FIG. 2, and FIG. 3. Additionally it shares the same FFMS 101a mechanical protection system as depicted in FIG. 3. It is differentiated in that FFMS 101a utilizes an alternate flow control device 130 which is actuated by a horizontal compressive (squeezing) force rather than the axial/vertical depression of an actuator such as actuator 113. To facilitate the actuation of flow control device 130, flow regulation device mover 131 is positioned such that it works in operable connection with restoring force block 133.

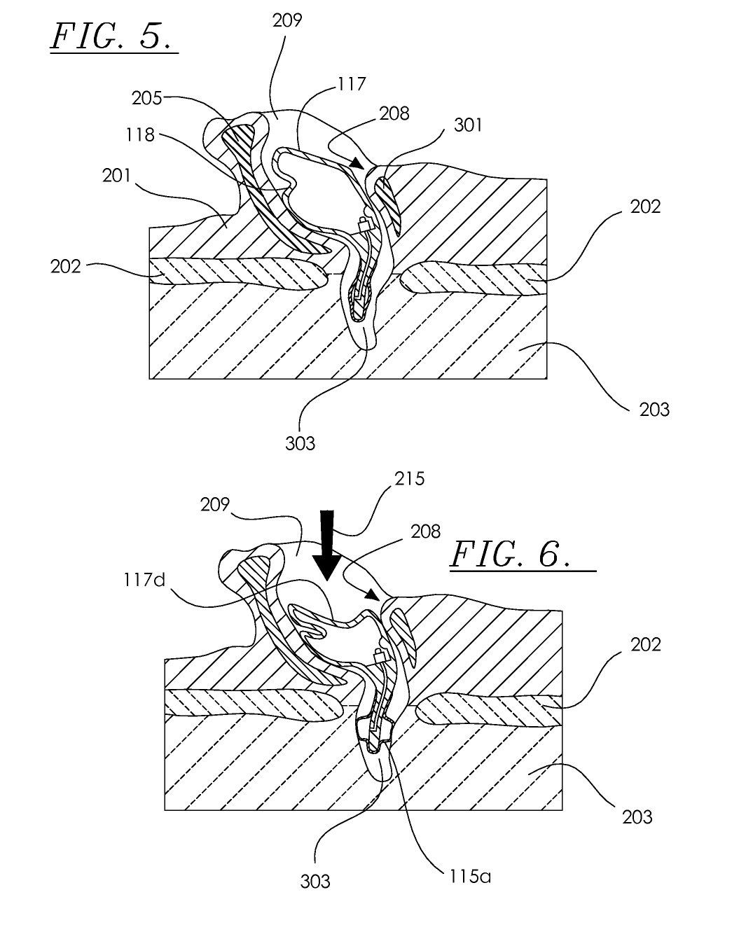

FIG. 5 depicts a cross sectional view of the embodiment of inflatable ear inserted device 200a, depicted in FIG. 2, inserted into a user's ear as shown in FIG. 1. In FIG. 5, IBS 102 is in operable connection with ear canal 303, FPS 100 dwells within concha 209 such that restoring force surface 117a is in operable connection with concha 209 and FFMS actuating surface 117b is in operable connection with tragus 208 with tragus cartilage 301 depicted. The embodiment depicted in FIG. 5 shows the device in its base/inactive state with IBS 102, FFMS 101 and FPS 100 inactivated.

FIG. 6 depicts the same cross sectional view of inflatable ear inserted device 200a, depicted in FIG. 5, in a state of FPS 100 and IBS 102 activation resulting in occlusion of ear canal 303. To achieve this state, force 215 is provided by prime mover onto FPS actuation surface 117 resulting in its movement into activated state 117d. Preferably, force 215 results in no movement of restoring force surface 117a and force 215 is ultimately transferred to skull bone 202 through restoring force surface 117a and met with roughly equal counter restoring force provided by the user through skull bone 202 resulting in no net motion of the device. As depicted and previously explained, FPS 100 is designed such that FPS actuation surface 117 deformation does not result in any appreciable increase in FPS 100 dimension. This is primarily due to compression guide groove 118 which is configured to ensure inward collapse of FPS 100 when compressed.

Upon application of force 215, the decrease in volume of fluid reservoir 110 results in a corresponding pressure increase. Once the internal pressure becomes greater than that required to move fluid through the FFMS 101 and inflate IBS 102, fluid will flow from fluid reservoir 110 through FFMS 101, through flow regulation device 112, down conduit 114, into IBS 102 resulting in the inflation of balloon 115 and occlusion of ear canal 303. Furthermore, deformation caused by force 215 does not cause activation of FFMS 101 by the movement of FFMS actuator surface 117b or any other physical contact. Additionally, FFMS actuator surface 117b remains in operable connection to tragus 208.

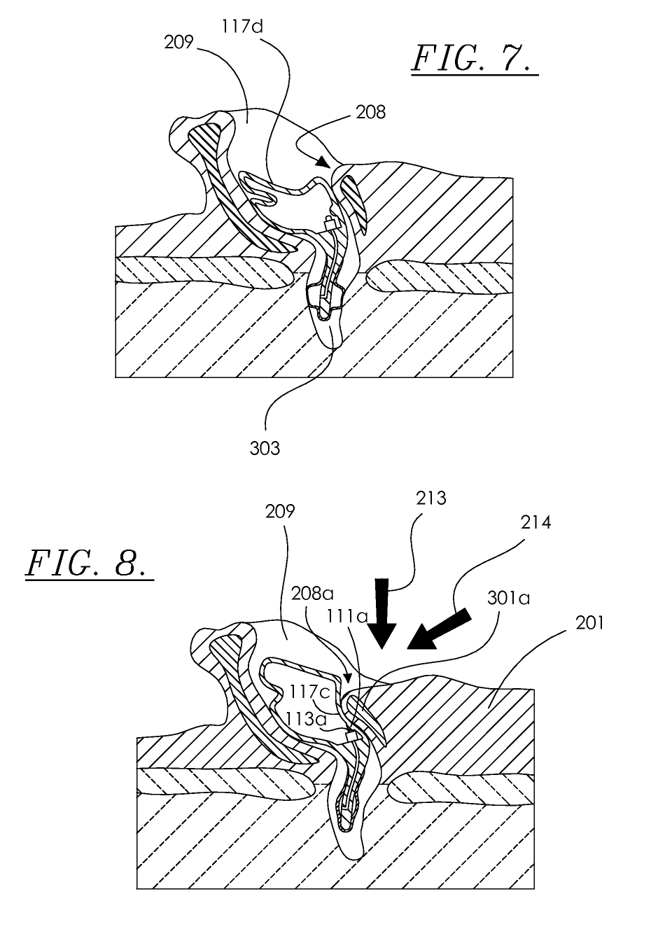

FIG. 7 depicts the embodiment depicted in FIG. 6 with force 215 removed. In this state, IBS 102 remains activated with balloon 115 preferably sealing ear canal 303. In the case of the closed system depicted here, the FPS actuation surface 117d remains in its activated state and FFMS 101 does not allow for movement of fluid.

Referring to FIG. 7, In the case of an open system (not shown), as described previously, FPS actuation surface 117d returns to its inactivated state 117 as fluid moves back into fluid reservoir 110 through a hole (not shown) to replace the fluid pumped through FFMS 101 into IBS 102. Once additional fluid has entered into fluid reservoir 110, the process of balloon 115 inflation as described in FIG. 6 may be repeated enabling the inflation of balloon 115 to a point where its interior volume may be larger than that of fluid reservoir 110. This facilitates the miniaturization of FPS 100 with respect to overall inflatable ear inserted device 200a size.

Depicted in FIG. 8 is the process of fluid release from IBS 102. Fluid release form IBS 102 is accomplished through the application of force onto outer skull soft tissue 201 which is operably connected and proximate tragus cartilage 301 and tragus 208. Upon the application of external force, such as force 213 and 214, by a prime mover, such as a user's finger, the adjacent tissue is deformed resulting in deformed tragus cartilage 301a and deformed tragus 208a. Their deformation transfers forces 213 and 214 to the operably connected FFMS actuation surface 117b resulting in its actuation into activated state FFMS actuation surface 117c and the movement of operably connected flow regulation device mover 111 into activated state flow regulation device mover 111a causing actuator 113 to move to alternate position shown by activated actuator 113a causing flow regulation device 112 to enter into an activated state enabling fluid to move from IBS 102 through conduit 114 through FFMS 101 into FPS 100. In an open system once flow regulation device 112 enters into the activated state, the driving force for fluid movement from IBS 102 to FPS 100 is provided only by compressive force provided by balloon 115 or adjacent impinged tissue of ear canal 303. In the case of a closed system driving force for fluid movement is that for an open system combined with the vacuum that is generated by the spring constant of the FPS 100 in an activated state.

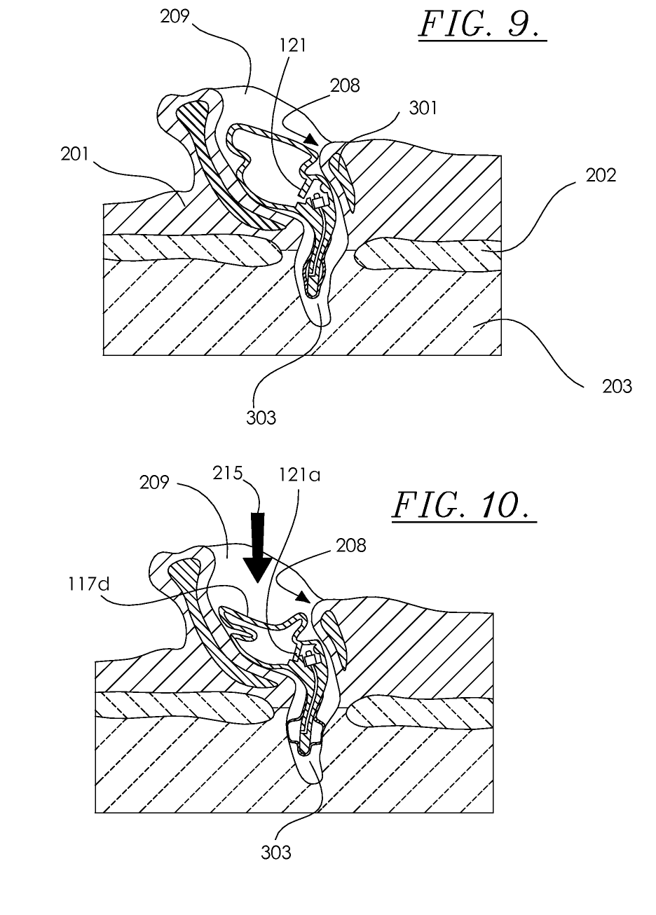

FIG. 9 depicts a cross sectional view of the embodiment of inflatable ear inserted device 200a depicted in FIG. 3 inserted into a user's ear as shown in FIG. 1 in a static state. As will be obvious, its position is identical to that shown in FIG. 5. As described previously the inflatable ear inserted device 200a depicted in FIG. 9 includes an IBS 102 identical to that of the embodiment depicted in FIG. 5 additionally, the function and operation of FPS 100 and FFMS 101a is identical. However the FFMS 101a of the device depicted in FIG. 9 incorporates a mechanical system to prevent any potential undesired actuation of flow regulation device 112. As explained previously, this mechanical protection system consists of FFMS actuator lock flap 121, FFMS actuator lock seat 122, FFMS protection compression groove 120 and FFMS protection system pivot point 123.

FIG. 10 depicts the embodiment of the inflatable ear inserted device 200a depicted in FIG. 9 with both FPS 100 and IBS 102 in the same activated state as described in FIG. 6. Unique to this figure is the mechanical protection system incorporated into FFMS 101a that prevents undesired actuation of flow regulation device 112. As depicted, when force 215 acts upon actuation surface 117 causing it to enter into actuated state 117d, FPS 100 deforms and compression guide groove 118 and FFMS protection compression groove 120 guide compression of FPS 100 and improves its mechanical efficiency. Compression groove 118 and FFMS protection compression groove 120 may be formed as a contiguous groove around the periphery of FMS 100. Attached to FFMS protection compression groove 120 is protruding FFMS actuator lock flap 121 which pivots around FFMS protection system pivot point 123 resulting in activated FFMS actuator lock flap 121a which comes into contact with FFMS actuator lock seat 122 preventing compression of FFMS actuation surface 117b and ultimately preventing undesired actuation of flow regulation device 112 during FPS 100 actuation.

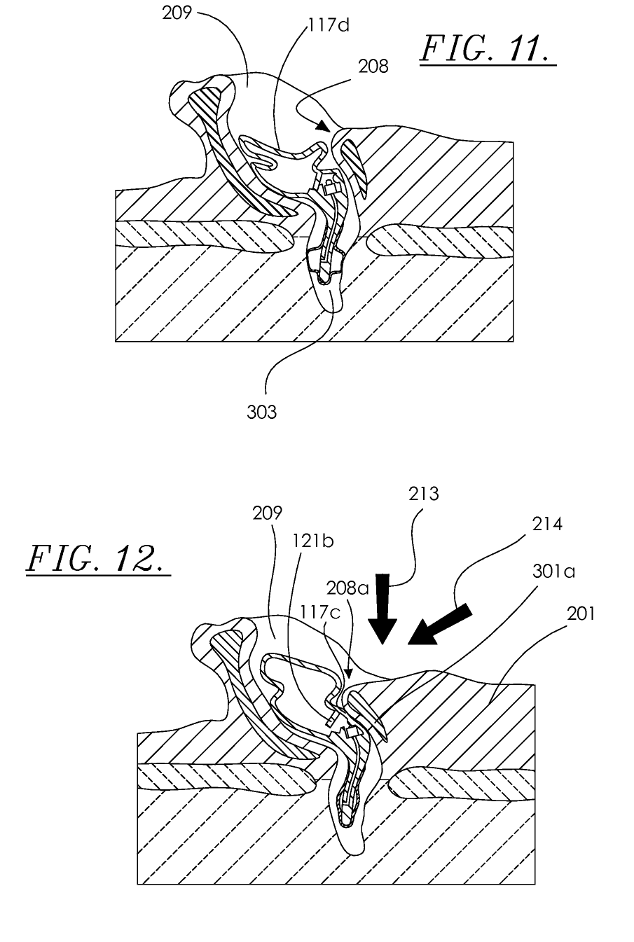

FIG. 11 depicts the embodiment depicted in FIG. 10 with force 215 removed. In this static state, IBS 102 remains activated with balloon 115 inflated sealing ear canal 303. In the case of the closed system depicted here, the FPS actuation surface 117d remains in its activated state and FFMS 101 does not allow for movement of fluid. In the case of an open system, as described previously, FPS actuation surface 117d returns to its inactivated state 117 as fluid moves back into fluid reservoir 110 through a hole (not shown) to replace the fluid pumped through FFMS 101 into IBS 102. Once additional fluid has entered into fluid reservoir 110, the process of balloon 115 inflation as described in FIG. 10 may be repeated enabling the inflation of balloon 115 to a point where its interior volume may be larger than that of fluid reservoir 110. This facilitates the miniaturization of FPS 100 with respect to overall inflatable ear inserted device 200a size.

Depicted in FIG. 12 is the process of fluid release from IBS 102. Fluid release form IBS 102 is accomplished through the application of force onto outer skull soft tissue 201 which is operably connected to tragus cartilage 301 and tragus 208. Upon the application of external force, such as force 213 and 214 by a prime mover, such as a user's finger, the adjacent tissue is deformed resulting in deformed tragus cartilage 301a and deformed tragus 208a. Their deformation transfers forces 213 and 214 to the operably connected FFMS actuation surface 117b resulting in its actuation into activated state FFMS actuation surface 117c and the unlocking of protruding FFMS actuator lock flap 121, which pivots around FFMS protection system pivot point 123, moving to release state protruding FFMS actuator lock flap 121b enabling the movement of operably connected flow regulation device mover 111 into activated state flow regulation device mover 111a causing actuator 113 to move to alternate position shown by activated actuator 113a causing flow regulation device 112 to enter into an activated state enabling fluid to move from IBS 102 through conduit 114 through FFMS 101 into FPS 100.

In an open system, once flow regulation device 112 enters into the activated state, the driving force for fluid movement from IBS 102 to FPS 100 is provided only by compressive force provided by balloon 115 or adjacent impinged tissue of ear canal 303. In the case of a closed system, driving force for fluid movement in an open system is combined with the vacuum that is generated when FPS 100 is in an activated state.

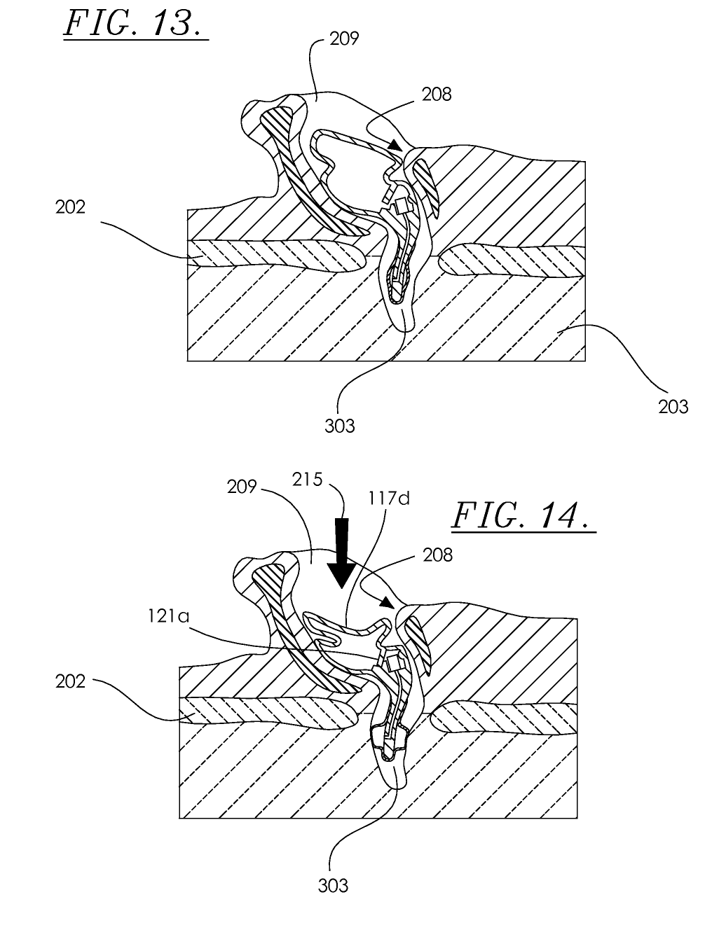

FIG. 13 depicts a cross sectional view of the embodiment of inflatable ear inserted device 200a depicted in FIG. 4 inserted into a user's ear as shown in FIG. 1 in a static state. As will be obvious to those skilled in the art, its position is identical to that shown in FIG. 9. As described previously the inflatable ear inserted device 200a depicted in FIG. 13 includes an IBS 102 identical to that of the embodiment depicted in FIG. 5 and the function and operation of FPS 100 and FFMS 101 is identical. However, the FFMS of the device depicted in FIG. 13 incorporates a mechanical system to prevent any potential undesired actuation of flow control device 130. Additionally flow control device 130 is actuated by a horizontal compression force rather than a vertical force as required by flow regulation device 112. Horizontal compression is facilitated by flow regulation device mover 131 positioned such that it works in operable connection with restoring force block 133 to facilitate actuation of flow control device 130. As explained previously, this mechanical protection system consists of FFMS actuator lock flap 121, FFMS actuator lock seat 122, FFMS protection compression groove 120 and FFMS protection system pivot point 123.

FIG. 14 depicts the embodiment of the inflatable ear inserted device 200a depicted in FIG. 13 with both FPS 100 and IBS 102 in the same activated state as described in FIG. 6. Unique to FIG. 14 is the mechanical protection system incorporated into FFMS 101a that prevents undesired actuation of flow control device 130 which is configured to be activated by an alternate actuation force. As depicted, when force 215 acts upon actuation surface 117 causing it to enter into actuated state of actuation surface 117d, FPS 100 deforms and compression guide groove 118 and FFMS protection compression groove 120 guide compression of FPS 100 and improve its mechanical efficiency. Attached to FFMS protection compression groove 120 is protruding FFMS actuator lock flap 121 which pivots around FFMS protection system pivot point 123 resulting in activated FFMS actuator lock flap 121a which comes into contact with FFMS actuator lock seat 122 preventing compression of FFMS actuation surface 117b and ultimately preventing undesired actuation of flow control device 130.

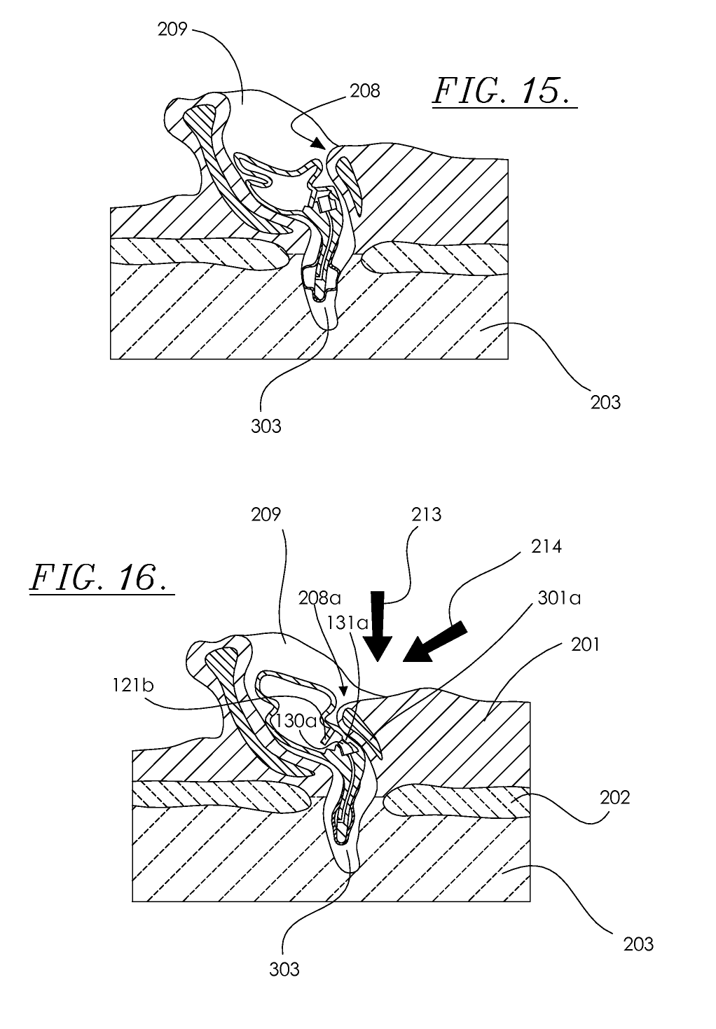

FIG. 15 depicts the embodiment depicted in FIG. 14 with force 215 removed. In this static state, IBS 102 remains activated with balloon 115 inflated sealing ear canal 303. In the case of the closed system depicted here, the actuated state of actuation surface 117d remains in its activated state and FFMS 101a does not allow for movement of fluid. In the case of an open system, as described previously, actuated state of actuation surface 117d returns to its inactivated state 117 as fluid moves back into fluid reservoir 110 through a hole (not shown) to replace the fluid pumped through FFMS 101a into IBS 102. Once additional fluid has entered into fluid reservoir 110, the process of balloon 115 inflation as described in FIG. 14 may be repeated enabling the inflation of balloon 115 to a point where its interior volume may be larger than that of fluid reservoir 110. This facilitates the miniaturization of FPS 100 with respect to overall inflatable ear inserted device 200a size.

Depicted in FIG. 16 is the process of fluid release from IBS 102. Fluid release form IBS 102 is accomplished through the application of force onto outer skull soft tissue 201 which is operably connected to tragus cartilage 301 and tragus 208. Upon the application of external force, such as force 213 and 214 by a prime mover, such as a user's finger, the adjacent tissue is deformed resulting in deformed tragus cartilage 301a and deformed tragus 208a. Their deformation transfers forces 213 and 214 to the operably connected FFMS actuation surface 117b resulting in its actuation into activated state FFMS actuation surface 117c and the unlocking of protruding FFMS actuator lock flap 121, which pivots around FFMS protection system pivot point 123, moving to release state protruding FFMS actuator lock flap 121b enabling the movement of operably connected flow regulation device mover 131 into activated state flow regulation device mover 131a providing a roughly horizontal force onto flow control device 130 pressing it against restoring force block 133 causing activated state flow regulation device 130a which enables fluid to move from IBS 102 through conduit 114 through FFMS 101a into FPS 100.

As will be obvious to those skilled in the art, an alternate configuration of device 200a may be developed which utilizes forces such as force 210, force 211, or force 212 depicted in FIG. 1 which are translated through adjacent tissue to actuate one or both systems FPS 100 and FFMS 101.

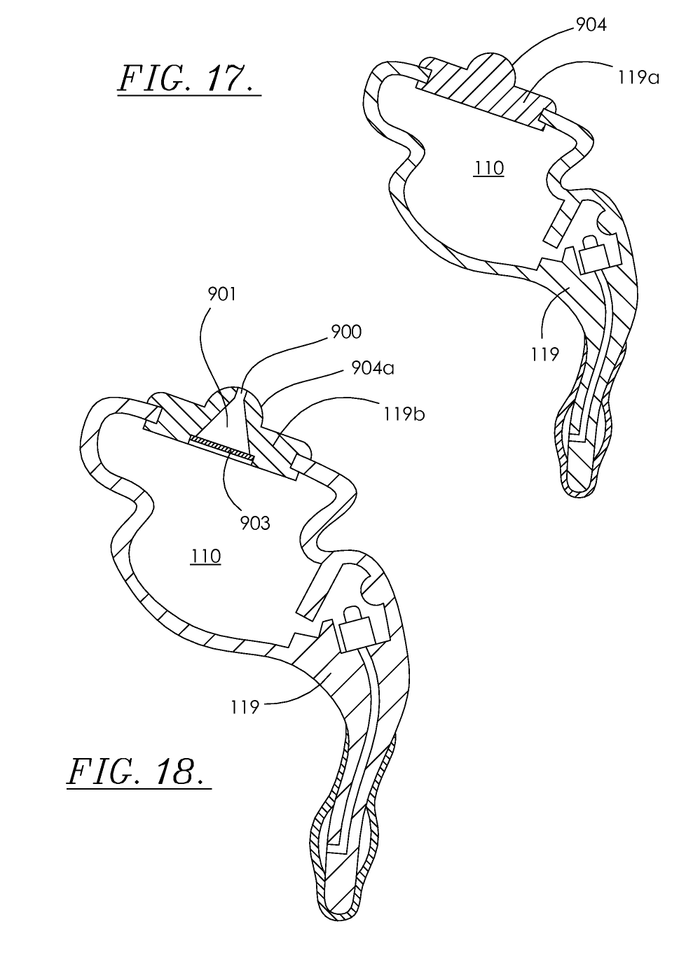

The embodiment depicted in FIG. 17 is that of FIG. 3 with FPS cap 119a in operable connection to device body 119 used to seal FPS fluid reservoir 110. In practice, it is impossible to form device body 119 as one piece thus, the optimal position for placing the required hole in device body 119 is on FPS actuation surface 117. In order to seal FPS fluid reservoir 110, FPS cap 119a is ideally bonded in place sealing FPS fluid reservoir 110. In order to aid in the operation of the device, it may be found advantageous to include cap bump 904 thereby helping users find the appropriate position for the application of an operable force.

FIG. 18 is an open system of embodiment depicted in FIG. 17. Unique to this embodiment are FPS cap fluid hole 900, FPS cap debris cavity 901, and filter media 903. In practice, user inserts the depicted device as previously described. Placing their finger on open cap bump 904a creating a seal of sufficient integrity as to enable buildup of pressure to that required to successfully operate the device. Factors affecting the integrity of the seal are the diameter of FPS cap fluid hole 900, the height and width of open cap bump 904a and the material composing FPS cap 119b. The smaller FPS cap fluid hole 900, the easier it will be to generate a seal of sufficient integrity. Ideal cap hole diameters are between 0.25 mm and 1 mm. Geometrical optimization of open cap bump 904a will also aid in generating a sufficient seal as a higher and narrower bump will generate more pressure around FPS cap fluid hole 900 with less force and thus less deformation of FPS and corresponding loss of fluid before a seal with sufficient integrity forms resulting in a more efficient FPS. Exemplary open cap bump 904a geometry would be a semispherical protrusion between 2 and 3.5 mm in diameter with an equivalent height. Alternately a conical shape could be utilized with similar height and width and a slope of between 45 and 60 degrees. With regards to material selection, the material should be relatively soft around the hole, however, the durometer of the material needs to be balanced with the design of FPS cap 119b and device body 119 to ensure sufficient pressure is generated around FPS cap fluid hole 900. If FPS cap 119b is too thin and has too low a durometer, than a sufficient seal may not form. If too thick and too high a durometer, the device may be uncomfortable to the user.

Operably connected to FPS cap fluid hole 900 is FPS cap debris cavity 901 and filter media 903 which work together to ensure debris that passes through FPS cap fluid hole 900 does not cause fluid flow blockage and prevents fouling of FFMS 101a by said debris. In operation any particulate matter that enters FPS cap fluid hole 900 does not remain thus blocking fluid flow but rather is designed to enter into operably connected FPS cap debris cavity 901 which is of a larger diameter. Operably connected filter media 903 prevents particulate matter from entering into FPS fluid reservoir 110 ensuring uninterrupted operation of FFMS 101a. Ideally, as depicted, filter media 903 area is substantially larger than area of FPS cap fluid hole 900 minimizing the impact particulate matter has on fluid flow.

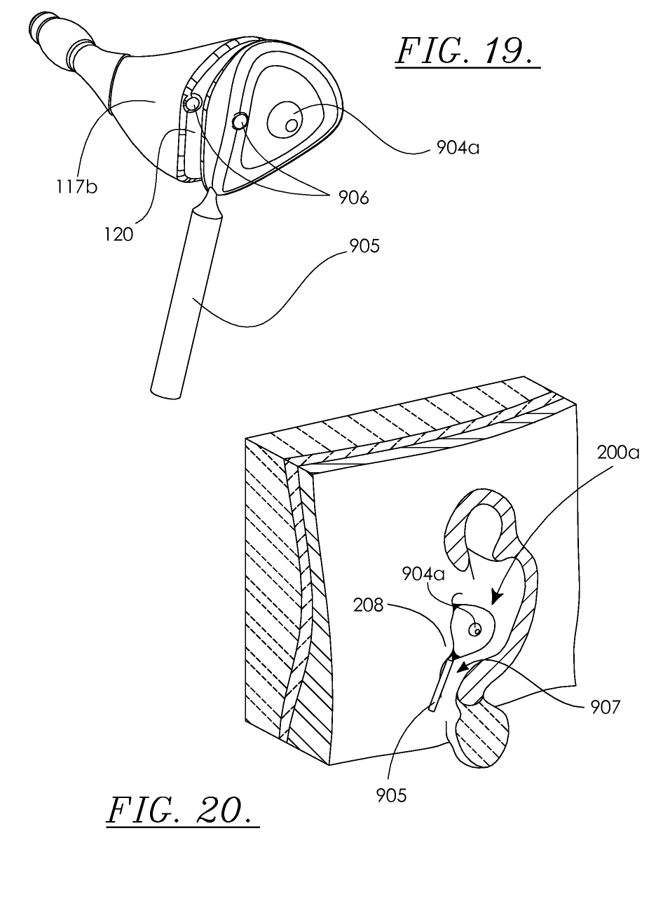

As conventionally preformed, inflatable ear inserted devices 200a may be marked with Left and Right markings with either letters or colors, however, the optimal operation of FPS 100, FFMS 101a, and IBS 102 makes proper alignment of the device critical to its comfort and operation. In order to aid the user in achieving proper insertion, FIGS. 10 and 10a depict an embodiment of device 200a with unique attributes that aid users in becoming adept at device insertion, orientation, and operation. Referring to FIG. 20, embodiment depicted in FIG. 19 is shown inserted in user's ear with the same positioning as previously described in FIG. 1. Referring to FIG. 19, an embodiment of inflatable ear inserted device 200a is depicted with tragus reference protrusions 906 shown along with intertragal notch alignment guide 905. Tragus reference protrusions 906 are preferably placed in the vicinity of FFMS actuation surface 117b in such a manner as to not protrude into tragus 208 causing discomfort but rather act as visual references to remind and/or teach the user to orient the device such that those bumps are adjacent to tragus 208. Physical protrusions, as shown here, may be replaced with color based reference markers to aid in orientation. An additional alignment guide, intertragal notch alignment guide 905, is preferably configured to be a detachable protrusion that is of sufficient proportions to make its presence and temporary status obvious. In practice this structure is placed such that when inserted correctly, it rests in the user's intertragal notch 907 as shown in FIG. 20. Once the user becomes accustomed to the appropriate orientation, intertragal notch alignment guide 905 is designed to be readily removed. An alternate form of alignment marking may be accomplished by using distinct colors at the juncture between intertragal notch alignment guide 905 and device body 119 which are aligned such that they are oriented in the intertragal notch 907. An alternate marking scheme, (not shown) may also be used which places colors on the top of the device, opposite the intertragal notch 907 adjacent to FFMS actuation surface 117b. Regardless their placement, it may be found advantageous to place these permanent markers in the region of compression guide groove 118 and FFMS protection compression groove 120 such that they are less obvious/visible once inserted and in use and do not interfere with the comfort of the device.

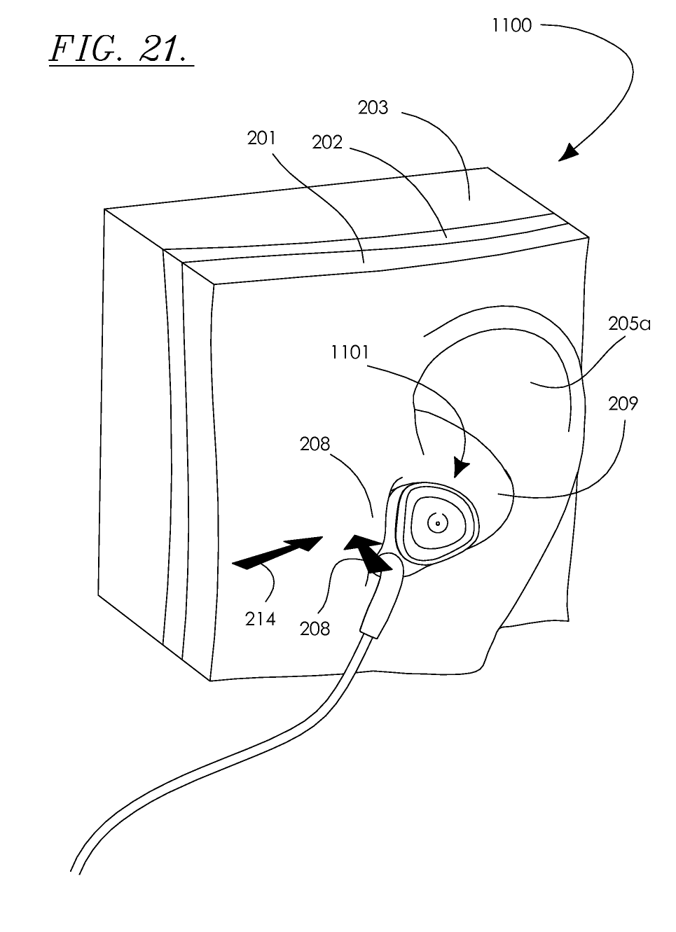

As previously discussed, the aforementioned orifice sealing devices may be coupled to a CSP to increase the functionality of the overall device. Depicted in FIG. 21 through FIG. 30 are two exemplary embodiments of how a CSP may be designed to be coupled with inflatable ear inserted device 200a and its various embodiments.

FIG. 21 depicts CSP-inflatable ear inserted device 1101 inserted in ear region 1100. As is depicted in the figure, ear region 1100 is similar to ear region 200 depicted in FIG. 1 however, the pinna depicted, pinna 205a, is in a complete state. Depicted within concha 209 is CSP-inflatable ear inserted device 1101.

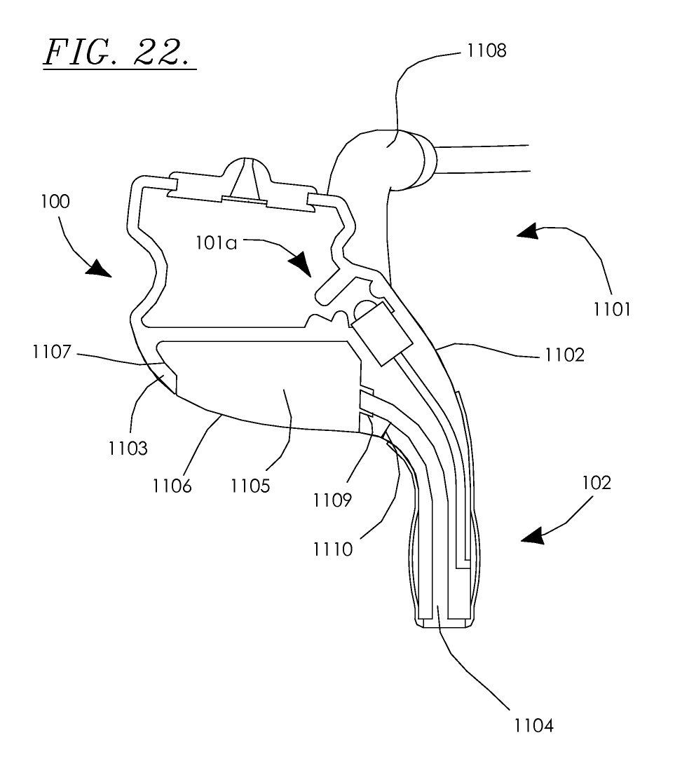

FIG. 22 depicts a cross sectional view of a non-limiting embodiment of CSP-inflatable ear inserted device 1101. CSP-inflatable ear inserted device 1101 is an alternate embodiment of inflatable ear inserted device 200a configured to be coupled with a CSP. CSP-inflatable ear inserted device 1101 utilizes identical subsystems of FPS 100, FFMS 101a, and IBS 102 with identical operation to those of inflatable ear inserted device 200a and are connected and incorporated into device body 1102. Device body 1102 is configured to contain CSP 1105 with CSP retention flap 1103 which is configured to substantially retain CSP 1105 via contact with CSP undercut 1107 of CSP 1105. As depicted in FIG. 22 CSP 1105 is preferably positioned such that CSP 1105 and any complementary conduits, such as conduit 1104, do not interfere with the operation of FPS 100, FFMS 101a, or IBS 102. In the depicted embodiment, CSP 1105 is positioned such that when in use, it is immediately adjacent concha 209. Depending on its functionality, CSP 1105 may be made in operable connection with the sealed orifice/ear canal via a conduit such as conduit 1104 which may be molded into device body 1102. As it may be desirable for CSP 1105 to be coupled to conduit 1104 with a pneumatic seal, CSP 1105 may utilize conduit barb 1109 which interfaces with conduit 1104 and ensures that a pneumatic seal is achieved. CSP 1105 may also possess a external interface 1108 which physically couples CSP 1105 to external devices. CSP 1105 may also possess CSP protrusion 1106 which may be included to increase the available internal volume of CSP 1105 for transducers and/or improve the retention of CSP 1105 by device body 1102.

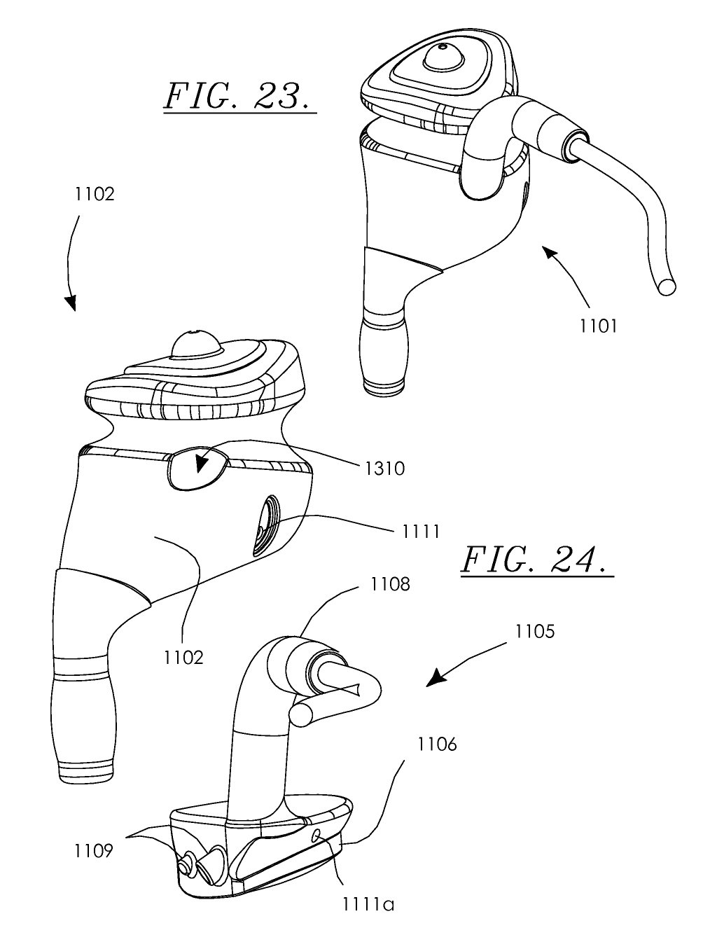

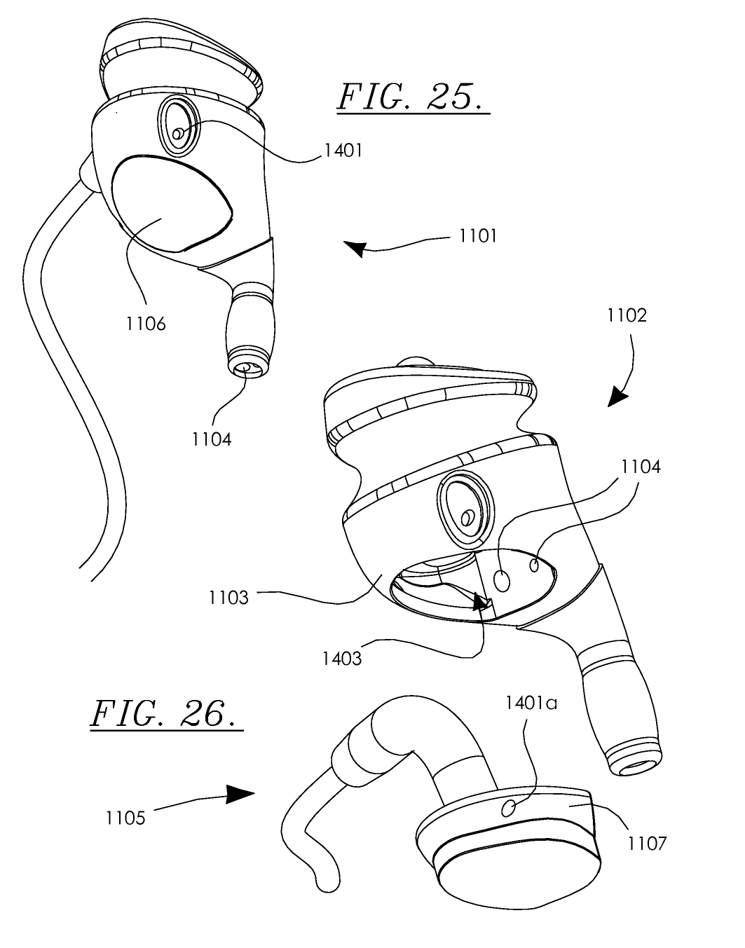

FIG. 23 depicts a front isometric view of CSP-inflatable ear inserted device 1101. FIG. 24 depicts CSP-inflatable ear inserted device 1101 separated onto its two independent components, device body 1102 and CSP 1105. FIG. 25 depicts a rear bottom isometric view of CSP-inflatable ear inserted device 1101 and FIG. 26 depicts a rear bottom isometric view of CSP-inflatable ear inserted device 1101 broken onto its two independent components, device body 1102 and CSP 1105. As will be obvious in light of the figures, CSP-inflatable ear inserted device 1101 is composed of two independent components, device body 1102 and CSP 1105 which are combined by threading external interface 1108 through device body opening 1403 and then CSP-external interface hole 1310 and then stretching CSP retention flap 1103 over CSP undercut 1107 securing CSP 1105 in device body 1102.

CSP 1105 may include transducers which may require access to ambient atmosphere. Front port 1111a depicted in FIG. 24 and back port 1401a, depicted in FIG. 26 are exemplary ports. As depicted in FIG. 23-26 said ports are covered by device body 1102 and are in operable connection with the ambient field via front device body port 1111 and back device body port 1401 respectively. As will be obvious, it is advantageous for said device body ports to be covered with a filter to ensure that debris does not enter into and clog front port 1111a and back port 1401a of CSP 1105.

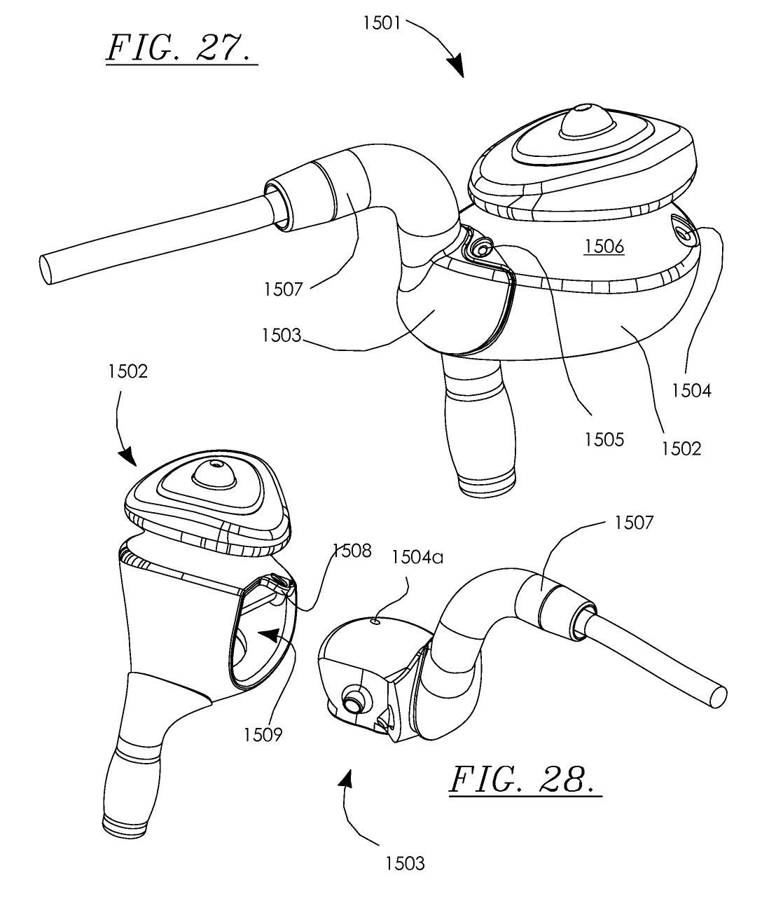

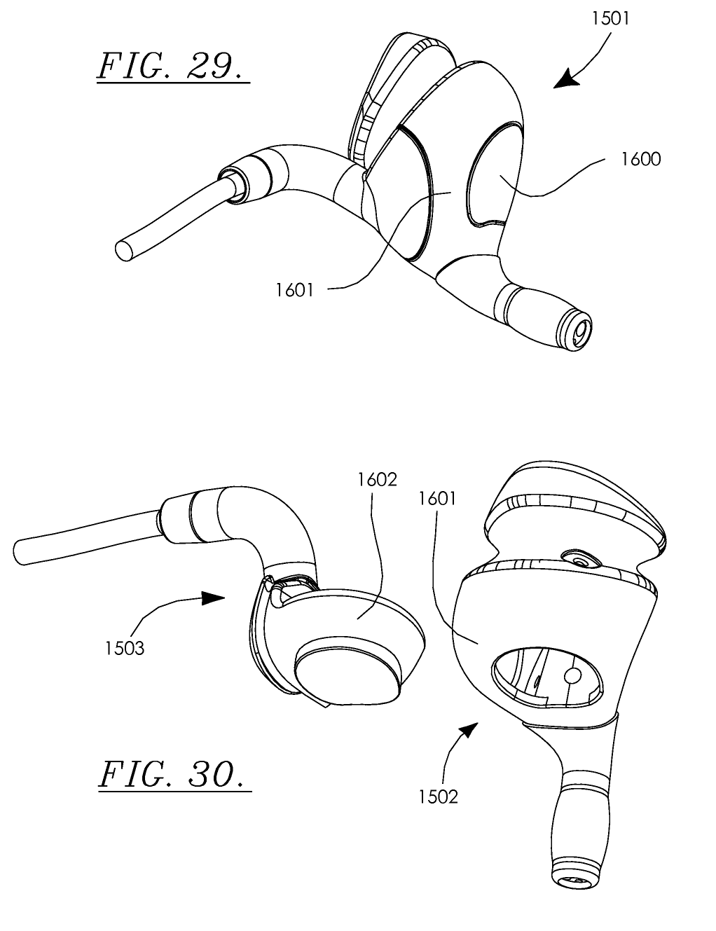

An alternate method of coupling a CSP to an inflatable ear inserted device is depicted in FIG. 27 through FIG. 30. FIG. 27 illustrates CSP-inflatable ear inserted device 1501 from a rear isometric view and FIG. 29 depicts CSP-inflatable ear inserted device 1501 from a bottom isometric view. CSP-inflatable ear inserted device 1501 is composed of two independent components, CSP 1503 and device body 1502 which are depicted in a separated state in FIG. 28 and FIG. 30. They are combined through the insertion of CSP 1503 into device body CSP cavity 1509 of device body 1502 and are held in operable connection by mechanical interference provided by stretching CSP retention flap 1601 over CSP undercut 1602 securing CSP 1503 in device body 1502. CSP protrusion 1600 may be incorporated into CSP 1503 and aid in increasing the amount of mechanical interference provided by the CSP retention flap 1601. As will be obvious in light of the illustrations and written description, the CSP-device body coupling methodology of side insertion enables the assembly of CSP-inflatable ear inserted device 1501 without having to pass external interface 1507 through any component of device body 1502.

CSP 1503 may include transducers which may require access to ambient atmosphere. In order to make CSP 1503 in operable connection with ambient atmosphere and ensure that CSP ports are not blocked by debris, front port 1505 of port flap 1508 and back port 1504, depicted in FIG. 27, may be incorporated into device body 1502 such that they cover and prevent debris from entering corresponding ports such as CSP back port 1504a and CSP front port (not shown). In order to ensure said ports are not blocked by any physical contact with the user's ear, they are positioned such that their orifices are placed in an area where skin contact is not probable such as on compression guide groove 1506 which is an operable equivalent to compression guide groove 118.

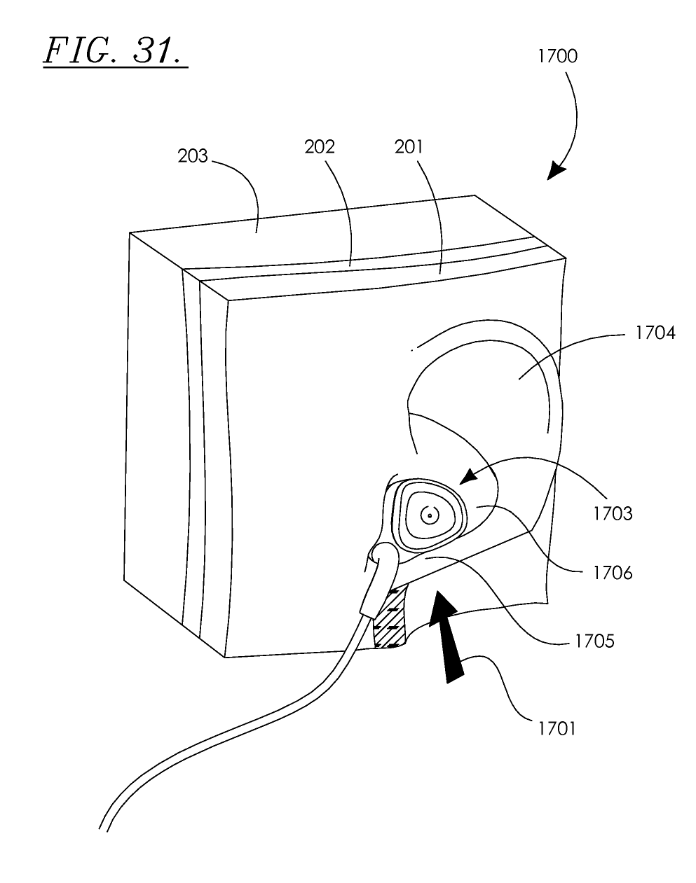

It may be found advantageous to include alternate and/or additional methods for incorporating and actuating an actuator of an inflatable ear inserted device. Illustrated in FIG. 31 through 33 is an alternate non-limiting methodology of applying an actuation force to tissue in operable connection with said device. As will be obvious, this alternate actuation methodology is non-exclusive and may be combined with alternate device actuation methodologies. FIG. 31 depicts under-concha actuated inflatable ear inserted device 1703 inserted into the outer ear 1704 of ear region 1700. Outer ear 1704 is depicted with the non-cartilaginous tissue below anti-tragus 1705 removed. In the depicted embodiment, under-concha actuated inflatable ear inserted device 1703 is actuated through the application of force 1701 from a prime mover onto the underside of the concha 1706 which is in operable connection with an actuation surface (not shown) of under-concha actuated inflatable ear inserted device 1703 ultimately resulting in device actuation.

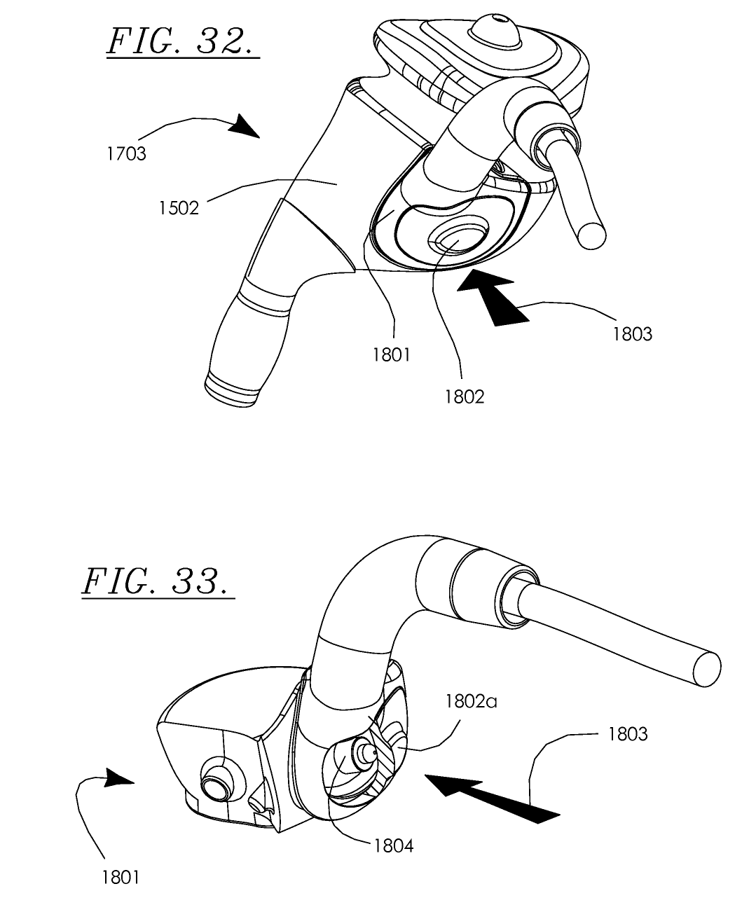

FIG. 32 depicts under-concha actuated inflatable ear inserted device 1703 which is composed of device body 1502 and indirect actuated CSP 1801. Indirect actuated CSP 1801 includes actuator cover 1802 which is configured to be actuated by force 1803. Force 1803 is generated by the transfer of force 1701 through tissue in operable connection by a prime mover. FIG. 33 is an isomeric view of CSP 1801 with actuator cover 1802 depicted in a cut away state, actuator cover 1802a, with actuator 1804 in operable connection.

As previously discussed, device body 1502 and CSP 1801 are independent units which are combined to form indirect actuated CSP 1801. In this exemplary embodiment, indirect actuated CSP 1801 may include actuator 1804, such as an electrical switch, to modulate the performance of transducers contained within. In practice, when the user wishes to actuate actuator 1804, they apply force 1701 from a prime mover onto the underside of the concha 1706 which is transferred through said tissue onto force 1803 which is applied onto actuator cover 1802 which ultimately actuates actuator 1804.

While the present embodiment utilizes force 1701 to cause actuation of an actuator contained within indirect actuated CSP 1801, an alternate embodiment may be configured such that force 1701 results in the actuation of an actuator contained within device body 1502.

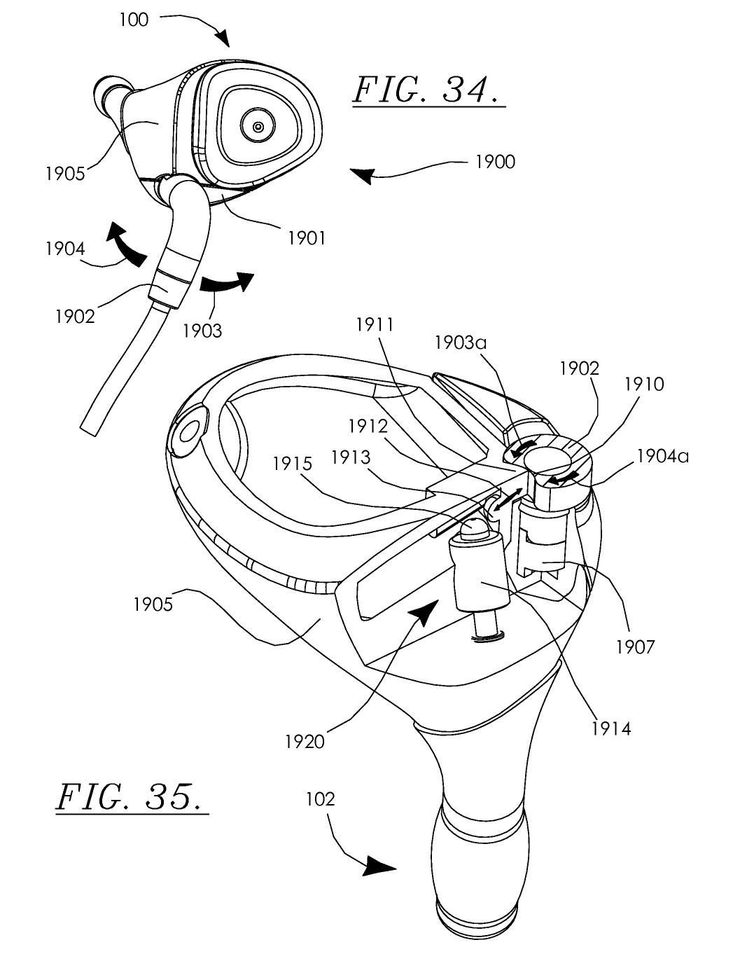

Depicted in FIGS. 34 and 35 is an alternate methodology for actuating an actuator of an inflatable ear inserted device. These figures illustrate an embodiment whereby force is applied by a prime mover to a device component which causes its rotation and ultimate actuation of said device. In the depicted embodiment, rotary actuated inflatable ear inserted device 1900, shown in FIG. 34, is composed of device body 1905 and rotating external interface CSP 1901. Device body 1905 is an operational equivalent of device body 1502 containing the systems of IBS 102 and FPS 100 however its FFMS, FFMS 1920, is functionally equivalent to FFMS 101, however it is configured such that it is actuated by force provided by rotating external interface CSP 1901. Rotating external interface CSP 1901 contains rotating external interface 1902 in operable connection which is configured to receive force 1904 and/or force 1903 from a prime mover which result in rotation of rotating external interface 1902 in the respective directions.

FIG. 35 depicts an isometric cutaway view of rotary actuated inflatable ear inserted device 1900 of FIG. 34 depicting an exemplary mechanism for converting the rotary motion of rotating external interface 1902 into actuation of flow regulation device 1914. This is accomplished through the conversion of the rotary motion of rotating external interface 1902 into a linear movement of rotary actuation protrusion 1913 which is configured to contact and actuate flow regulation device actuator 1915 resulting in the change of state of flow regulation device 1914 from closed to open. In this exemplary embodiment, the conversion of the rotary movement into linear is performed by cam indentation 1910 of rotating external interface 1902 which is in operable connection with cam protrusion 1911 of device body 1905. As is obvious in light of the figures, force 1904 is converted into rotation of rotating external interface 1902 in the direction indicated by force 1904a in a like fashion, force 1903 causes rotation of rotating external interface 1902 as indicated by force 1903a. Rotation of rotating external interface 1902 in either direction causes cam protrusion 1911 to be pushed linearly in direction 1912 causing rotary actuation protrusion 1913 in operable connection to actuate flow regulation device actuator 1915 of flow regulation device 1914. Upon removal of force 1904 or force 1903, spring material 1907 in operable connection with rotating external interface 1902 and rotating external interface CSP 1901 preferably provides a force that returns rotating external interface 1902 to its initial position thereby enabling the deactivation of flow regulation device 1914 as rotary actuation protrusion 1913 returns to its un-activated position due to spring constant of material comprising device body 1905.

The mechanism depicted has rotary motion of rotating external interface 1902 coupled to rotating external interface CSP 1901, however, an alternate embodiment may have rotary motion of rotating external interface 1902, or an operational equivalent, coupled to a derivative of device body 1905.

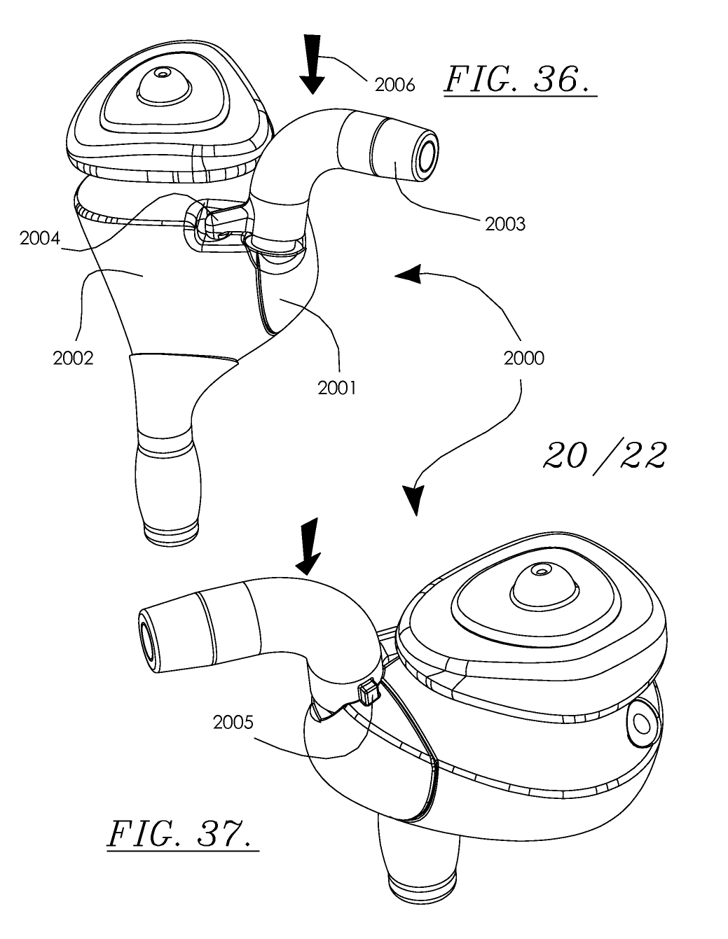

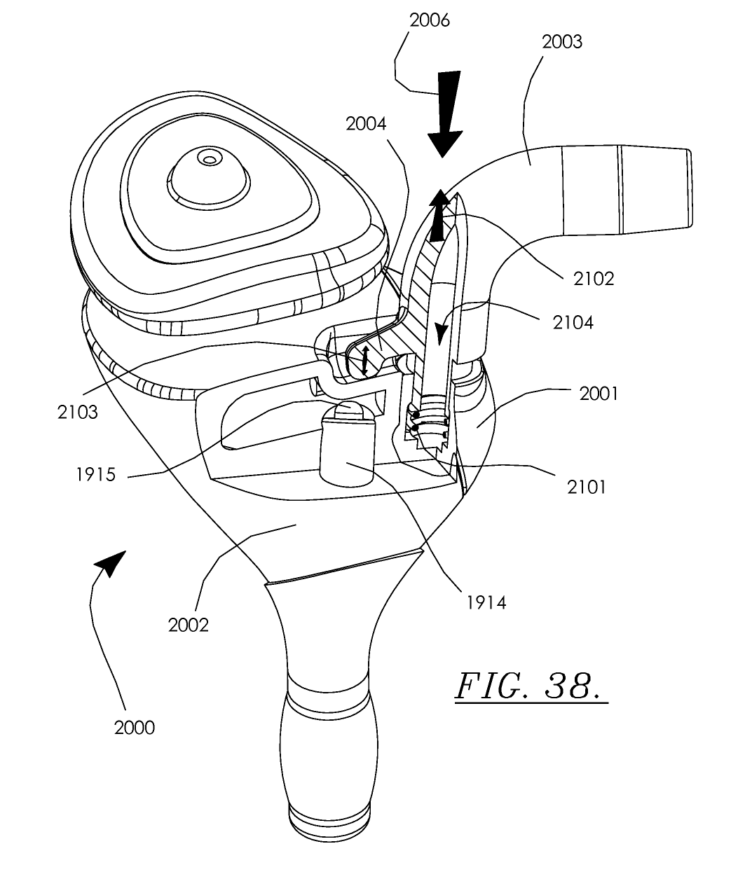

An alternate methodology of actuating an actuator may be the application of a linear force onto a device component which translates this force to the appropriate actuator surface. FIGS. 36-38 depict an alternate embodiment of the present invention which utilizes linear motion of external interface 2003, rather than rotary motion, to cause device actuation. In practice, inflatable ear inserted device 2000 includes device body 2002 and linear external interface actuated CSP 2001 which contains external interface 2003 that is configured such that it is able to move along an axis and is rotationally fixed by guide block 2005. Linear movement into the device body of external interface 2003 in response to the application of force 2006 is opposed by spring 2101 which is configured to enable the passage of external interfaces, such as electrical wires, through external interface internal conduit 2104 providing opposing force 2102 returning external interface 2003 to its initial state upon the removal of force 2006. External interface 2003 preferably includes actuation arm 2004 which is configured to be in operable connection and transfer force 2006 to flow regulation device actuator 1915 of flow regulation device 1914 causing it change to an open state. Upon removal of force 2006, spring 2101 provides opposing force 2102 which raises external interface 2003 to its initial position and enables flow regulation flow regulation device actuator 1915 of flow regulation device 1914 to return to its static state.

As will be obvious, the two aforementioned actuation methods of linear or rotary movement of an external interface or an operational equivalent thereof may be utilized to actuate any multitude of actuators, rather than the actuation of a FFMS, which may be contained within a device body or a CSP. Additionally, they may be coupled with alternate actuation methodologies previously described to increase the functionality of the overall device.

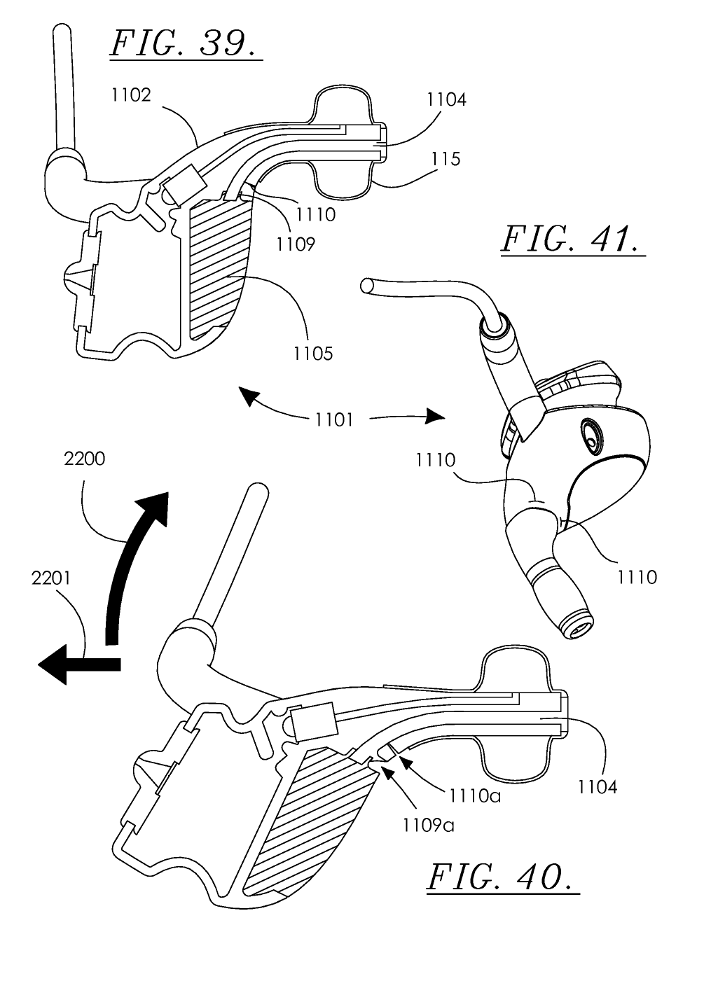

FIGS. 39, 40, and 41 depict two systems whereby the seal created by IBS 102 may be affectively broken in a manner other than through the disconnection of balloon system 115 with orifice walls. Such a system may be advantageous during the intended or unintended removal of the disclosed embodiments of the present invention. As will be obvious to those skilled in the art, these techniques are described in relation to CSP-inflatable ear inserted device 1101, however, they may be adapted to other embodiments or be composed of alternate equivalent systems.

The first system utilizes a conduit, such as conduit 1104, in operable connection with the sealed portion of the orifice such as the ear canal. In operable connection with this conduit is a pressure relief valve 1110 which is configured as a positive and negative pressure “blow off valve” with a manual release. In the instance where the device is configured to be used in operable connection with the human ear canal and IBS 102 and balloon system 115 is in its occluding state, pressure relief valve 1110 static default state is sealed and it enables flow in the forward or reverse direction at an ideal minimum pressure differential of approximately between 3.0 and 10.0 kPa. Additionally, when the user desires to remove the device or it is removed inadvertently, pressure relief valve 1110 is preferably configured such that removal forces, such as tension force 2201 and sheer force 2200, act against the appreciably fixed IBS 102 causing pressure relief valve 1110 to stretch open resulting in pressure relief valve gap 1110a enabling flow in both directions thereby mitigating any pressure differential between sealed portion of orifice and the ambient field. As removal forces may come from various directions, it may be advantageous to include several pressure relief valve 1110 as depicted in FIG. 41 so that any applied removal force will result in the opening of at least one pressure relief valve 1110. As will be obvious to those skilled in the art and depicted in FIGS. 39, 40, and 41, pressure relief valve 1110 may be formed as a slit valve or an operable equivalent.

The second system depicted in FIGS. 39, 40, and 41 for pressure relief within the sealed orifice utilizes a conduit such as conduit 1104 in operable connection with the sealed portion of the orifice such as the ear canal and CSP 1105. As previously described, CSP 1105 may include conduit barb 1109 which is ideally configured to seal with conduit 1104 in its static state. In the instance when forces such as tension force 2201 and sheer force 2200 are applied with the CSP-inflatable ear inserted device 1101 installed in the orifice and IBS 102 in its occluding state, the forces cause conduit barb 1109 to be disconnected from conduit 1104 resulting in the formation of CSP-conduit barb gap 1109a which enables the displacement of any pressure differential between the ambient field and the sealed orifice. Preferably the aforementioned system will be configured such that forces, such as tension force 2201 and sheer force 2200, result in the formation of CSP-conduit barb gap 1109a and thus pressure relief when the pressure differential created by the application of external forces on the device is equal to or greater than approximately 3.0-10.0 kPa.

What is claimed is:

1. An orifice occluding device comprising:
a fluid pumping system (FPS) operable to flow fluid as a result of the direct application of force;
a fluid flow management system (FFMS) operable to selectively control the flow of fluid configured such that a change in flow state is achieved through the application of a force onto the material adjacent the device when in use;
an inflatable balloon system (IBS) operable to dilate and contract in response to the flow of fluid and cause orifice occlusion.

2. The orifice occluding device of claim 1, wherein:
the FFMS includes a locking mechanism which prevents actuation of FFMS during FPS operation.

3. The orifice occluding device of claim 1 wherein:
the device is configured to be coupled with a Complementary Systems Package (CSP).

4. The orifice occluding device according to claim 3, wherein;
the CSP possesses a protrusion which when assembled with the orifice occluding device protrudes from the device body through a hole

5. The orifice occluding device according to claim 3, wherein;
the CSP possesses an actuator which is configured to be actuated by a force applied to material adjacent the device when in use.

6. The orifice occluding device according to claim 3, wherein;
the CSP possesses a protrusion which extends from the device and is configured to cause actuation of FFMS through rotation about an axis.

7. The orifice occluding device according to claim 3, wherein;
the CSP possesses a protrusion which extends from the device and is configured to cause actuation of FFMS through linear movement along an axis.

8. The orifice occluding device according to claim 1, wherein;
the device contains a valve in fluidic connection with the occluded orifice and ambient atmosphere configured mitigate a pressure differential between the occluded orifice and ambient atmosphere.
